(19) United States
(12) Patent Application Publication
(10) Pub. No.: US 2018/0218546 A1
(43) Pub. Date: Aug. 2, 2018

(54) SPATIO-TEMPORAL MONITORING AND PREDICTION OF ASSET HEALTH

(71) Applicant: International Business Machines Corporation, Armonk, NY (US)

(72) Inventors: Shivkumar Kalyanaraman, Chapel Hill, NC (US); Ravindranath Kokku, Ossining, NY (US); Vinay K. Kolar, Elmsford, NY (US); Saket K. Sathe, White Plains, NY (US)

(21) Appl. No.: 15/419,094

(22) Filed: Jan. 30, 2017

(51) Int. Cl. G07C 5/00; G01M 17/00

(52) U.S. Cl. CPC G07C 5/006; G01M 17/00

(57) ABSTRACT

Obtaining position data of an asset; obtaining one or more context sensor signals, each context sensor signal representing a real-time measured parameter related to the asset; in near-real-time, updating a function that determines a present usage rate of the asset based on the position data, weighted values of the context sensor signals, and an immediate past usage status; in near-real-time, estimating an asset time to failure based on the updated function and a future asset task allocation; and based on the estimate of asset time to failure, and in near-real-time, adjusting the future asset task allocation.

### BACKGROUND

The present invention relates to the electrical, electronic and computer arts, and, more particularly, to telemetric monitoring of mobile mechanical asset status and the like.

Mobile assets (e.g., passenger automobiles, freight trucks, railcars, mining vehicles, and the like) are subject to wear and tear over time due to travel. Accordingly, preventive maintenance is desirable to prevent unexpected equipment breakdowns. Typically, preventive maintenance has been scheduled based on operator experience or more often based on OEM estimates (in engine run hours or miles driven) of component life.

### SUMMARY

Principles of the invention provide techniques for spatio-temporal monitoring and prediction of asset health. Further principles of the invention provide techniques for regional analysis of asset health. In one aspect, an exemplary method includes obtaining position data of an asset; obtaining one or more context sensor signals from the asset, each context sensor signal representing a real-time measured parameter related to the asset; in near-real-time, updating a function that determines a present usage rate of the asset based on the position data, weighted values of the context sensor signals, and an immediate past usage status; in near-real-time, estimating an asset time to failure based on the updated function and a future asset task allocation; and based on the estimate of asset time to failure, and in near-real-time, adjusting the future asset task allocation.

Other aspects of the invention provide a computer program product that includes a computer readable storage medium embodying computer executable instructions. When executed by a computer, the instructions cause the computer to facilitate the inventive method as discussed above.

Other aspects of the invention provide an apparatus that includes a memory; a plurality of sensors; and at least one processor, coupled to the memory and the sensors, and operative to obtain position data of an asset; obtain one or more context sensor signals from the plurality of sensors, each context sensor signal representing a real-time measured parameter related to the asset; in near-real-time, update a function that determines a present usage rate of the asset based on the position data, weighted values of the context sensor signals, and an immediate past usage status; in near-real-time, estimate an asset time to failure based on the updated function and a future asset task allocation; and based on the estimate of asset time to failure, and in near-real-time, adjust the future asset task allocation.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

As used herein, “near-real-time” indicates that an action or calculation is performed substantially concurrently with a relevant measurement, i.e. quickly enough to provide a practical closed-loop control system. The significance of near-real-time will be apparent to an ordinary skilled worker in context of the measurements to be made and the actions to be taken in response to the measurements.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

With reference to heavy industries such as mining or oil and gas production, in mining each truck costs between $5-6.5 million. A typical mine uses hundreds of expensive trucks and other assets (loaders, bucket elevators, bulldozers, etc.), which undergo constant wear-and-tear. Lack of monitoring or maintenance can cause untimely critical failures resulting in large operational costs for unscheduled downtime not only of the failed equipment, but of an entire production line that depends on the failed equipment. Therefore, operators need an effective way to constantly predict asset health and to act to reduce operational costs, i.e. by properly scheduling times when assets should be serviced or replaced (based on asset health and expected loads). In order to predict asset health, it is important for operators to have answers to a few questions:

Which regions are causing more usage (wear-and-tear) to which equipment?

Which regions are critical and rugged to which equipment?

What weaker equipment causes bottlenecks for newer equipment in which regions?

Aspects of the invention provide industry operators the capabilities to:

Judge the return on capital expenditure;

Reducing the operational costs of production;

Deploy right equipment at the right place for the right purpose;

Optimize resource allocation and fine-tune maintenance schedule.

The system and method can be applied to any industry with moving assets. For example, mining, oil and gas production, or deep-sea resource exploration.

Techniques of the present invention can provide substantial beneficial technical effects. For example, one or more embodiments may provide one or more of the following advantages:

Equipment (Asset) health monitoring and prediction system using sensor data, wireless connectivity and spatio-temporal analytics;

Region analytics based on the wear-and-tear (usage) observed in different spatial regions;

Improved (“just in time”) scheduling of preventive maintenance;

Near-real-time identification of problem areas for movement of mobile assets;

Improved (health-based) allocation of assets to tasks;

Improved employment (near-real-time route and task selection) of mobile assets.

Thus, aspects of the invention provide for real-time movement tracking of vehicular equipment, including updates of side-channel information (such as roads on which the vehicle is moving). Additionally, movement tracking updates can tag vehicular and environmental sensor readings to the location (GPS data) and task (vehicle allocation data). Vehicular sensor readings can include, for example: vibration readings, engine RPM, loaded weight; orientation, angular velocity, accelerometer data.

Aspects of the invention can overlay a vehicle position on a map of routes, and can compute an equipment trajectory and route. By associating context attributes such as sensor readings to the trajectory, certain aspects can develop spatio-temporal learning and prediction models of wear-and-tea (usage) on the vehicular equipment. Additionally, task assignment data can be combined with trajectory information and associated context attributes to learn spatio-temporal usage models for a combination of a task and a region, e.g., hauling a trailer along a given segment of road. Multi-variate spatial correlation and clustering can be used to analyze and visualize different regions of equipment wear and tear.

In further aspects, trajectory data from different items of vehicular equipment can be combined for spatio-temporal analysis of congestion bottlenecks, in order to compute blocking causes for an equipment (e.g., a new truck slowed down because of older low-speed trucks were blocking).

Further aspects enable proactive service schedule computation, based on usage data and prediction using spatio-temporal analytic results in combination with future planned equipment-to-task allocations. Additionally, such aspects can enable smart allocation of equipment that can handle wear-and-tear for a set of tasks, based on the regions in which the tasks are scheduled, and expected loads and equipment and requirements from other tasks.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIGS. 3A and 3B show inputs and outputs of spatio-temporal learning modules according to embodiments of the invention;

FIG. 4 shows a geospatial information map that is useful in embodiments;

FIG. 5 shows data provided to spatio-temporal learning modules according to embodiments;

FIG. 6 shows data inferred by spatio-temporal learning modules according to embodiments;

FIG. 7 shows in tabular form a process implemented by the spatio-temporal learning modules according to embodiments of the invention;

FIG. 8 depicts the spatio-temporal modules according to embodiments of the invention;

FIG. 9 shows a flowchart of the process shown in FIG. 7;

FIG. 10 shows a flowchart of a final step of the process shown in FIG. 7; and

FIG. 11 depicts a computing system configurable to implement embodiments of the invention.

### DETAILED DESCRIPTION

The subject matter of the instant application will be described with reference to illustrative embodiments. Numerous modifications can be made to these embodiments and the results will still come within the scope of the invention. No limitations with respect to the specific embodiments described herein are intended or should be inferred.

Although a particular embodiment of the invention is described in detail herein with reference to heavy off-road mining equipment, it is to be understood that the invention is equally applicable to other sorts of mobile assets—e.g., highway trailer trucks, school and commuter buses, rail vehicles, armored vehicles, airplanes, oil drilling rigs, and the like.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

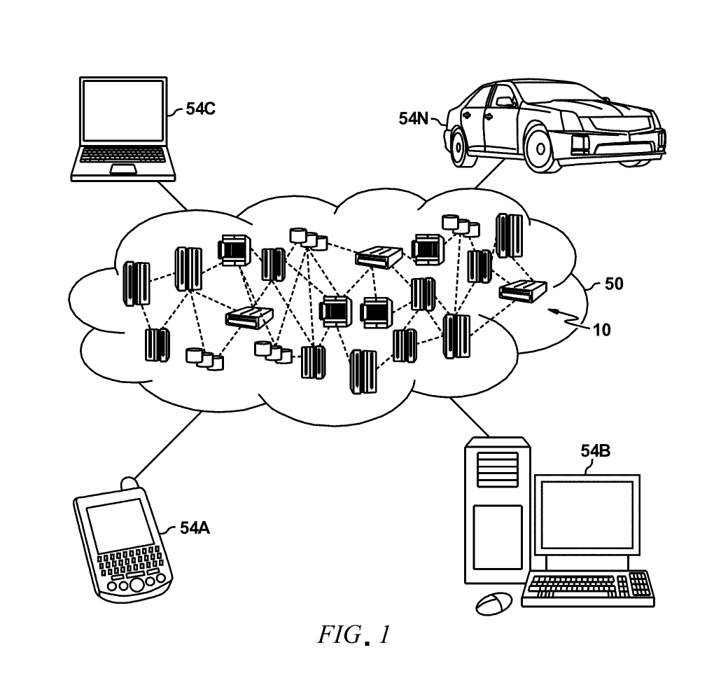

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

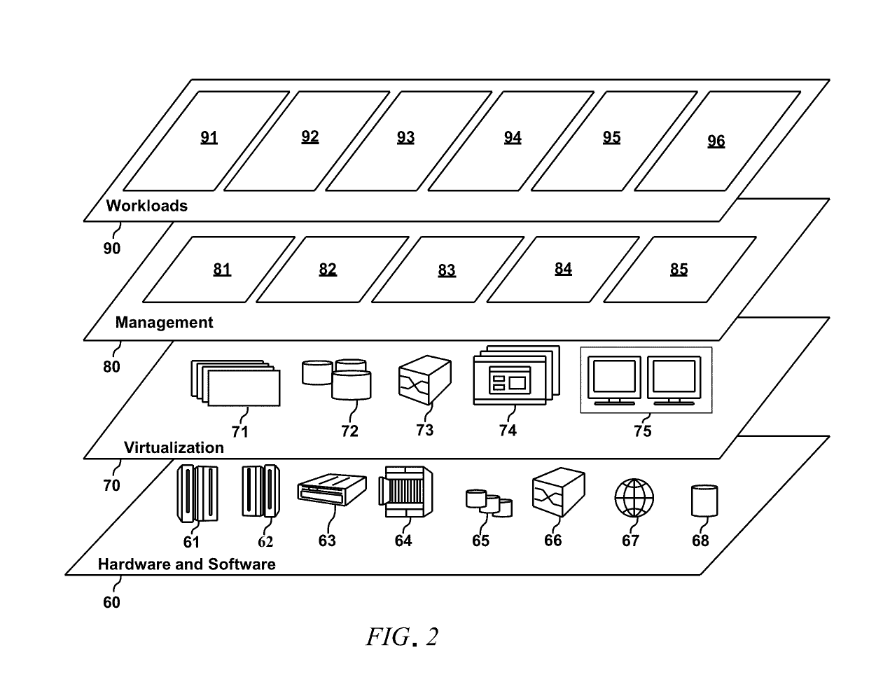

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and an asset health management system 96.

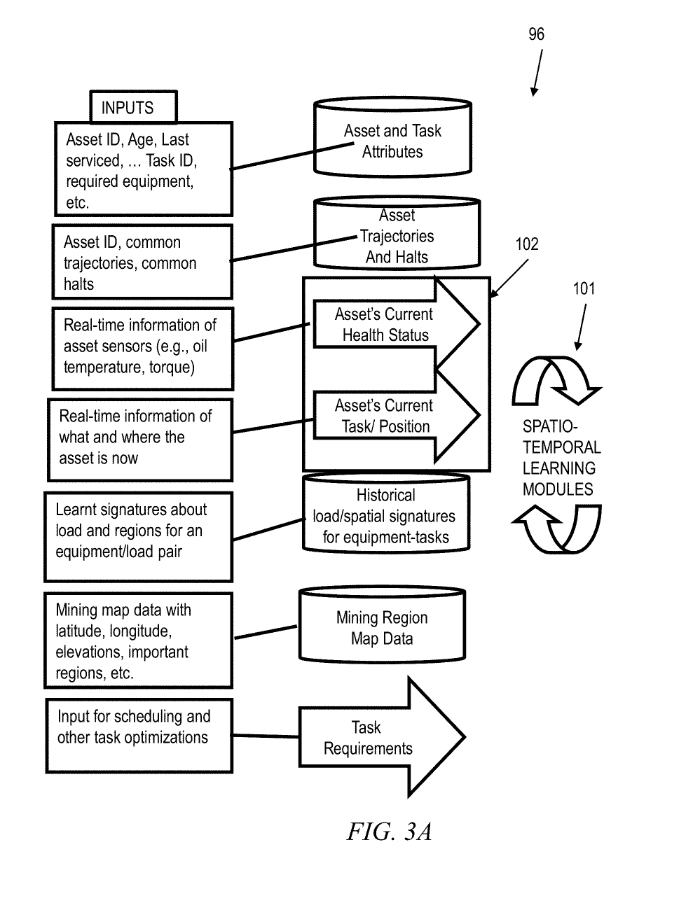

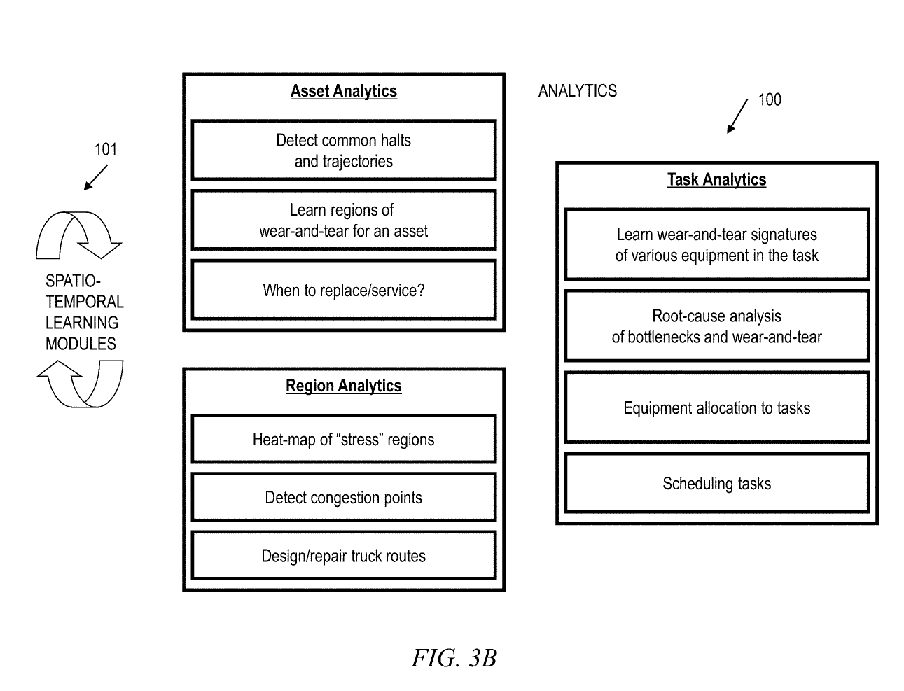

Referring now to FIGS. 3A and 3B, the asset health management system 96 according to embodiments of the invention facilitates one or more spatio-temporal learning modules 101 and one or more asset monitoring modules 102. Each of the spatio-temporal modules 101 receives asset time and location (GPS) data as well as contextual data (e.g., equipment load, environmental temperature, equipment temperatures, humidity and rainfall, engine vibration, noise, and power, tire pressure, and the like) from the asset monitoring modules 102. The GPS data and the contextual data are plotted on a map in the nature of geospatial information system (GIS) data. Based on the GIS data, as well as asset specifications and expert opinion correlating various component measurements to asset health, the spatio-temporal learning modules 101 derive asset health data from which the following operational insights (analytics) are obtained:

Common halts or service interruptions (bottlenecks) among assets sharing a trajectory (route or task list);

Regions of highest asset usage;

Expected time until component failure;

Optimal time for scheduling preventive maintenance;

Asset congestion points;

Routes or task lists to be repaired or re-designed;

Usage signatures of various assets allocated to a task;

Root-cause analysis of bottlenecks and asset usage;

Optimal allocation of assets to tasks;

Optimal task scheduling.

Additionally, daily reports on asset health can be provided.

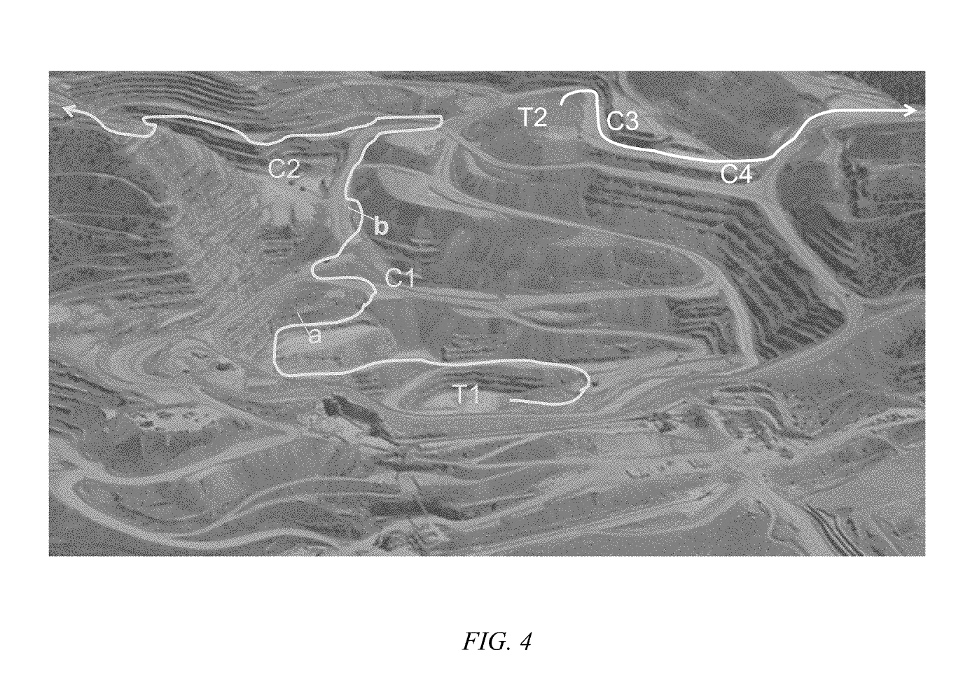

For example, with reference to FIG. 4, consider two tasks T1 (moving mined material from the lower pit) and T2 (moving mined material from the upper pit). T1 is assigned trucks C1, C2 (say, of the same make and similar usage). T2 is assigned trucks C3 and C4. Our approach recognizes trajectories (GPS data) used for task T1 and T2 (and for assets C1, . . . , C4).

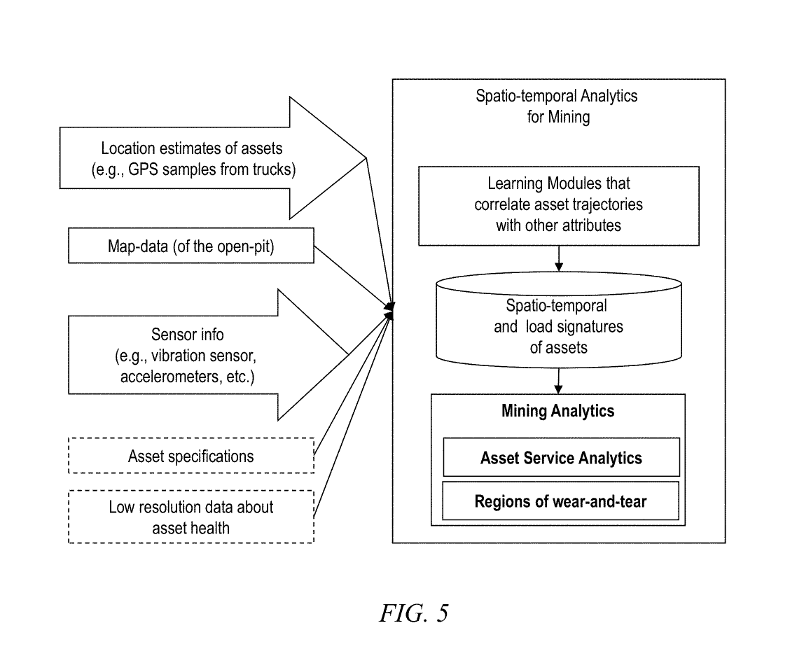

Thus, referring to FIG. 5, the spatio-temporal modules 101 continuously associate temporal vehicular health data (e.g., engine RPM, tire pressure, oil pressure, coolant pressure, bearing vibration, engine noise) and contextual sensor data (e.g., vibration, elevation, orientation, temperature, humidity, precipitation, road surface wetness) for each of the trajectories obtained from the map data and GPS location data. Using this rich spatio-temporal data, the spatio-temporal module 101 builds a usage model for vehicles that are moving on trajectories T1 and T2. Thus, the spatio-temporal modules 101 are able to recognize what regions are causing more usage, for example, whether a part of the trajectory from ‘a’ to ‘b’ for task T1 is slippery during rains. Therefore, an operator might consider changing the route of the trucks for T1 during rains. Additionally, the spatio-temporal modules 101 may predict that C1, C2 need to be serviced/changed more often than C3, C4. Furthermore, the spatio-temporal modules 101 can detect common halts for assets that share one of the trajectories T1, T2 and can thereby diagnose which of the several assets has caused a common halt.

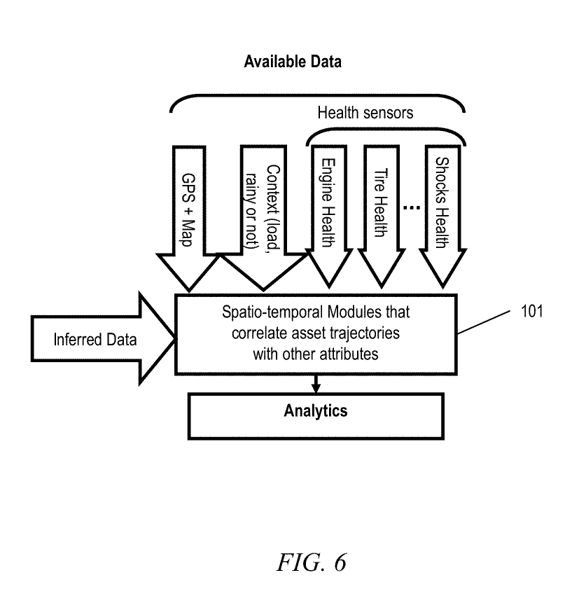

Referring to FIG. 6, there are two types of contextual data that can be used for estimating asset usage rates: available data, which includes GPS data, sensor data from the vehicles or other sensing units (orientation, accelerometers, ambient temperature, humidity, etc.); and inferred data, which includes data that can be inferred using the available data, e.g. finding out speed and gear number from gross weight and grade.

Regarding the spatio-temporal analysis of asset health data, and the building of a usage model for assets moving on particular trajectories, let there be a set of R spatial regions monitored: For example, let a given trajectory comprise a set of R road-segments (e.g., a road network {r₁, r₂, . . . r_{R}}) on which mobile assets travel. The R segments could also be regions or areas of space, e.g., drilling strata in deep water resource exploration. Then let xᵢ(r,t) be the values of ‘m’ contextual sensors either directly observed or inferred at a spatio-temporal point (time t on region r). We can derive the “health differential” or “usage rate” of a component when it travels on segment r. The usage rate yᵢ(r) is the amount that the health Hᵢ of a component decreases when travelled on segment r, i.e. the amount of wear-and-tear on the component. The health of a component is a parameter that can be derived from the data h(t) that is provided by the vehicular health sensors, in a manner apparent to the ordinary skilled worker. For example, health of a component can be thought of a quantity between 0 and 1, where 1 indicates healthy and 0 indicates unhealthy/failure state. Common measures of health can be normalized to the 0-1 range. For example, a tire is known to be good for 10,000 miles, then immediately after it is installed it has health of 1 and after 5000 miles it has health of 0.5, etc. But, it may happen that if the tire is operated on rough terrain, then after 5000 miles its health could be estimated as 0.3 by domain experts. Thus, given several instances of such health assessments by domain experts, it is possible to learn the coefficients c_i and W_i,j for the purpose of prediction.

Thus, let yᵢ(r,t) be the usage rate of a component i at time t while on region r. Then the usage rate of n components=<y1(r,t), y2(r,t), . . . , yn(r,t)>. The y vector can be segmented in each region (road) based on binding the spatio-temporal information to the sensor values. There are m contextual factors <x1(r,t), x2(r,t), . . . , xm(r,t)> (from sensor values), correlated to the usage rate of each of the n components by weighting vector W, that are observed on the road. For example, such contextual factors include x1=load on the vehicle, x2=temperature, x3=raining intensity. These contextual factors or sensor signals can be obtained from sensors in-built to the asset, or from external (third party) sensors, e.g., a mobile phone sensor package can provide location, temperature, and vibration data. The problem solved by the spatio-temporal modules 101 then is to determine the usage rate (y) of a component when it moves in a given spatial region r: yᵢ(r,t)=cHᵢ(t−1)+Wᵢx(r,t), where Hᵢ(t) is the overall health of a component i at a time t; c is a component model factor based on design information and accounting for design-expected component deterioration; and Wᵢ is an m-dimensional weight vector that correlates the usage rate of component i to the m context sensor readings. Wᵢ may be learnt by the spatio-temporal modules 101 or may be provided as an expert input to the modules 101. Some of the weight values in Wᵢ may be zero according to whether a particular context sensor j has any correlation to wear-and-tear of a given component i.

Considering the process of learning W, assume that m sensors provide input into usage rate (health decrement) of n components. We can learn the effect or weight vector W that relates the contextual factors to the health H of a system, for example, by regression based learning on W. We now know how each road segment affects health of each component under various contexts (in a spatio-temporal space); e.g., if a truck travels on road r₁ under context <x₁, . . . xₘ>, then the decrement in its health of its engine, H_{engine}, is given by y_{engine}(r1,t)=cH_{engine}(t−1)+W_{engine}x(r1,t).

Then, given a schedule of travel for a vehicle in the next few days, we can predict the overall health decrease. For a time of travel (T) to (T+d), there is a context vector x=<x₁^{(r,t)}, x₂^{(r,t)}, . . . xₘ^{(r,t)}> for t=(T) to (T+d). The vehicle will travel on roads or regions R={r₁, r₂, . . . , rₛ}. Given a health differential curve for a component i: (yᵢ^{(r,t)}) that was learned from previous travel, then by integrating the health differential curve over T to T+d, it becomes possible to estimate components' health after future travel according to the following formula.

Health before the travel at time t=Hᵢ^{t}

Health after travel at time (t+1)=Hᵢ^{t+1}=Hᵢ^{t}−Σ_{r∈R}yᵢ^{r}

Consider that the real time context vector x enhances future prediction. The relationship between the context vector and the health differential components is learned using past data. In the prediction phase (i.e., in real time) when the context vector is provided from the context sensors, the health differential is computed and is compared to the measured change in health that is derived from the health sensors. A cumulative sum of the health differential is maintained on-the-fly to give real time health scores and to enhance learning of the sensor weight vector W. Having the context vector available makes the approach real time because the context vector can be immediately converted to a real time health differential and can help real time scoring. Meanwhile, the future predicted health score is continually updated based on the current health score and prior knowledge of wear-and-tear likely to be experienced on the upcoming road segments R.

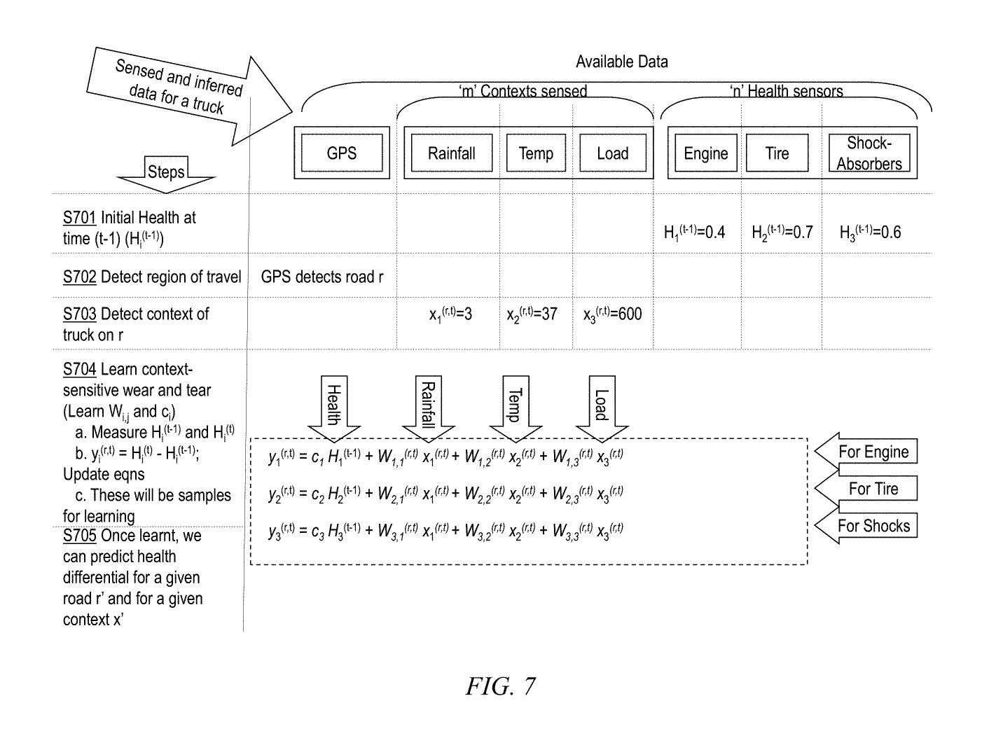

FIG. 7 illustrates in tabular form the process discussed above. At a step S701, the system (i.e. the spatio-temporal modules 101) obtains initial health readings Hᵢ from the various health sensors. At a step S702, the system obtains GPS data to detect a current road segment r. At a step S703, the system obtains context data from the contextual sensors x. At a step S704, the system calculates usage rates yᵢ based on comparing the initial health readings Hᵢ(t−1) to current health readings Hᵢ(t). The system then uses the computed usage rates yᵢ to learn the values of the sensor weight vectors Wᵢ and of the component model factors cᵢ. At a step S705, the system then uses the learned values of Wᵢ and of cᵢ in predicting future usage rates yᵢ(t+1). Consider that while a future road segment r′ can be selected, future context x′ is not known; therefore, future context can be estimated based on the selected road segment r′ and based on proposed task allocation, among other variables (e.g., weather forecast, anticipated road wear due to other vehicles transiting).

We can now compute the time when each component of the asset needs to be serviced: when the health of the given component at a given time, Hᵢ^{(t)}<Lᵢ (Lᵢ=some threshold). Given a vehicle x with some components, we now have predictions of the health differentials of each of the components. Thus, from the above method, we can compute mean service time for a component of an asset. Under certain context, under certain schedule (roads that it will travel), it also is possible to estimate an overall time-to-breakdown of the asset, when the health of any component i of the vehicle becomes <Lᵢ.

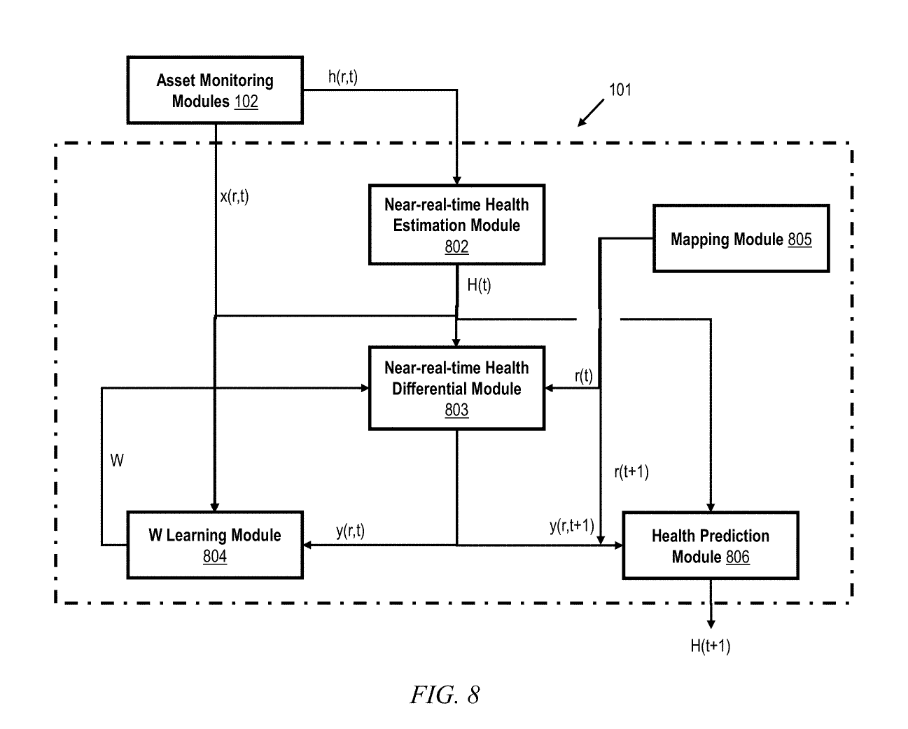

FIG. 8 depicts submodules of the spatio-temporal modules 101. In particular, the asset monitoring modules 102 send health sensor data h(r,t) at S701 to a near-real-time health estimation module 802, and send context sensor data x(r,t) at S703 to a near-real-time health differential module 803 and to a W (sensor weight vector) learning module 804. A mapping module 805 provides map data (GPS location, future trajectory, etc.) at S702 to the health-differential module 803 and to a health prediction module 806. The sensors module (asset monitoring module) 102 also sends the context sensor data x(r,t) to the health prediction module 806. Meanwhile, the health estimation module 802 sends near-real-time health estimates H(t) to the health differential module 803 and to the health prediction module 806. The health differential module 803 sends current usage rates y(r,t) at S704 to the W learning module 804, and sends predicted usage rates y(r,t+1) to the health prediction module 806. The health prediction module 806 produces an estimate of future health, H(t+1) at S705.

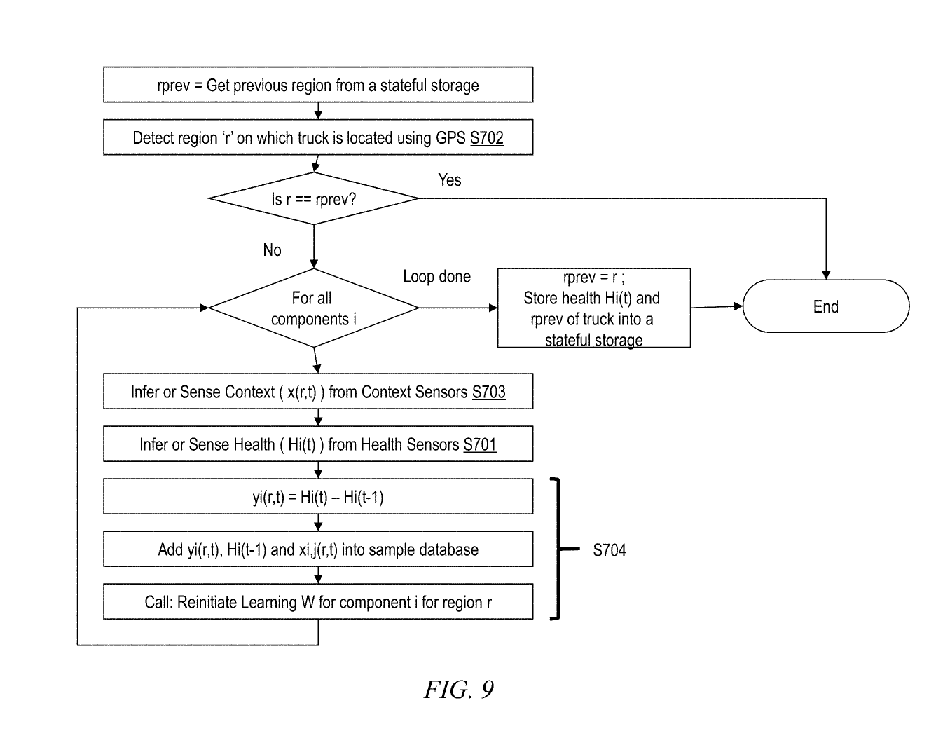

According to another aspect of the invention, FIG. 9 depicts a flowchart of steps S701-S704 of the process also shown by FIG. 7, which may be accomplished in a variety of sequences as can be seen by comparing FIGS. 7 and 9.

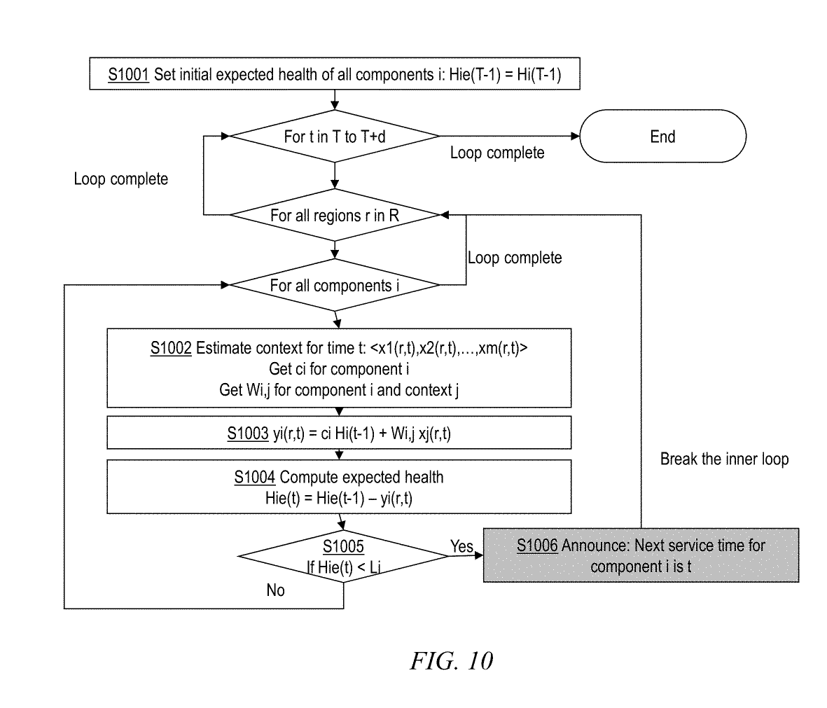

FIG. 10 depicts a flowchart of step S705, which includes the following substeps. At S1001, the system (spatio-temporal modules 101) sets an expected health vector Hᵢₑ(T−1)=Hᵢ(T−1) the initial measured component health. Then, for t from present time T to future time T+d, the system iterates steps of estimating at S1002 context sensor values (based, e.g., on weather forecasts, estimates of road wear, allocated task) and retrieving learned values of cᵢ and Wᵢ, predicting at 51003 usage rate yᵢ, and computing at S1004 expected health of each component, Hᵢₑ(t). At each iteration, the system compares at 51005 the expected health of each component to a component health threshold In case Hᵢₑ(t)<Lᵢ, the system announces at S1006 that the component (and the asset containing the component) will be due for service at time t.

Additionally, it is possible to estimate the top-k regions of highest usage and to obtain a heat-map of health-differentials/usage rates. Thus, the operators can also use the analytics for optimization of operations: Where should newer roads or routes be built? Which trajectories cause most wear-and-tear? This enables least-cost routing of assets for given tasks, i.e. given ‘n’ possible routes or tasks, which route or task an asset should take to minimize the health decrease or cost of servicing. Additionally, given a task that requires a vehicle to travel on road-set R, it is possible to choose vehicles which can accomplish the task with least health differential or cost of servicing.

Assume that we are tracking the wear-and-tear of one component C. This component could be anything from engine, tire, or an entire truck. Let <x>ₜ be the values of all the sensors either directly observed or inferred at time t. Then the differential wear-and-tear y(t) is the wear-and-tear underwent by component C between time t and t−1 and is given by the following equation: yₜ=cYₜ₋₁+Wxₜ, where c and w are vector valued parameters of the system that can be learned or set using domain knowledge. In summary, with each time t and road segment rₜ we have associated a differential wear-and-tear yₜ. Then wear-and-tear (usage) on component C between t₁ and t₂ is given by Σᵢ₌ₜ₁^{t2}yᵢ, and, to find how much a road segment rₚ affected component C between time t₁ and t₂: Σᵢ₌ₜ₁^{t2}y(rᵢ). Then it is possible to find which is the worst road between time t₁ and t₂ by computing aggregated wear indicators for all roads r₁ . . . rₙ, sorting and finding the worst.

Throughout the above description of an illustrative embodiment, related to mining operations, we have referred to “r” as a “road segment” described by geographic position data as may be obtained from GPS. However, in other applications—e.g., in oil and gas production—“r” may instead denote a rock layer characterized by parameters such as thickness, hardness, and toughness, with vertical position data as may be obtained from a well log.

Given the discussion thus far, and with reference to the drawing Figures, it will be appreciated that, in general terms, an exemplary method, according to an aspect of the invention, includes obtaining position data of an asset (S702); obtaining one or more context sensor signals from the asset (S703), each context sensor signal representing a real-time measured parameter related to the asset; in near-real-time, updating a function (S704) that determines a present usage rate of the asset based on the position data, weighted values of the context sensor signals, and an immediate past usage status; in near-real-time, estimating (S705) an asset time to failure based on the updated function and a future asset task allocation. The method also may include adjusting the future asset task allocation in near-real-time based on the estimate of asset time to failure. For example, an adjustment of asset task allocation may re-allocate an asset from production tasking to maintenance tasking. The method also may include obtaining one or more health sensor signals from the asset (S701). The health sensor signals may include power output, vibration, and noise. The context sensor signals may include a weight, a gear position, an orientation, an angular velocity, an acceleration, elevation, orientation, oil pressure, coolant pressure, or tire pressure. In some aspects, the context sensor signals may be weighted in the function by sensor weight factors that are determined based on the position data. Also, the context sensor signals may be weighted in the function by sensor weight factors that are determined based on history of component usage. The method also may include estimating one or more regions of higher than average usage rate; producing a heat-map of usage rates; maintaining a history of usage rates correlated to position data; and/or, based on the history of usage rates for the asset, estimating in near-real-time a usage of an asset allocated to a particular task. In certain aspects, the immediate past usage status may be weighted in the function by a component model factor. For example, the component model factor estimates a degree of incremental wear of a component of the asset, based on health sensor signals. Some embodiments of the inventive method include establishing a vector of sensor weight factors based on a history of component usage. Some embodiments also include providing a system of distinct software modules, each of the distinct software modules being embodied on a computer-readable storage medium. For example, the distinct software modules may include an asset monitoring module 102, a health differential module 803, and a health prediction module 806. A step of obtaining context sensor signals is carried out by the sensors module executing on at least one hardware processor; a step of updating the function is carried out by the health differential module executing on the at least one hardware processor; and a step of estimating an asset time to failure is carried out by the health prediction module executing on the at least one hardware processor.

Other aspects of the invention provide a computer program product that includes a computer readable storage medium embodying computer executable instructions. When executed by a computer, the instructions cause the computer to facilitate any of the inventive methods as discussed above.

Other aspects of the invention provide an apparatus that includes a memory; a plurality of sensors; and at least one processor, coupled to the memory and the sensors, and operative to obtain position data of an asset; obtain one or more context sensor signals from the plurality of sensors, each context sensor signal representing a real-time measured parameter related to the asset; in near-real-time, update a function that determines a present usage rate of the asset based on the position data, weighted values of the context sensor signals, and an immediate past usage status; and, in near-real-time, estimate an asset time to failure based on the updated function and a future asset task allocation. The processor also may be operative to adjust the future asset task allocation in near-real-time based on the estimate of asset time to failure. In certain embodiments, the processor also may be operative to establish a vector of sensor weight factors based on a history of component usage.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

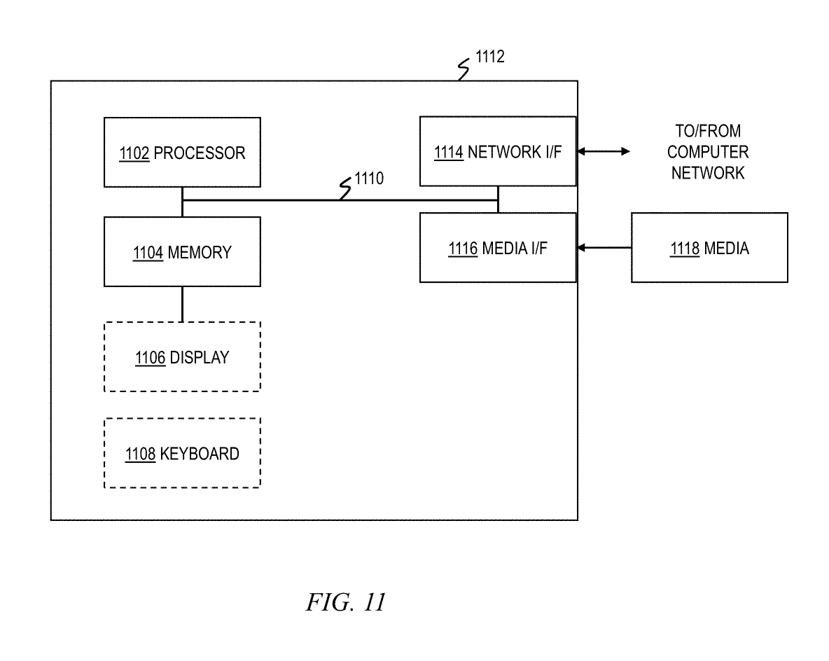

One or more embodiments can make use of software running on a general purpose computer or workstation. With reference to FIG. 11 such an implementation might employ, for example, a processor 1102, a memory 1104, and an input/output interface formed, for example, by a display 1106 and a keyboard 1108. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1102, memory 1104, and input/output interface such as display 1106 and keyboard 1108 can be interconnected, for example, via bus 1110 as part of a data processing unit 1112. Suitable interconnections, for example via bus 1110, can also be provided to a network interface 1114, such as a network card, which can be provided to interface with a computer network, and to a media interface 1116, such as a diskette or CD-ROM drive, which can be provided to interface with media 1118.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1102 coupled directly or indirectly to memory elements 1104 through a system bus 1110. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1108, displays 1106, pointing devices, and the like) can be coupled to the system either directly (such as via bus 1110) or through intervening I/O controllers (omitted for clarity).

Network adapters such as network interface 1114 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1112 as shown in FIG. 11) running a server program. It will be understood that such a physical server may or may not include a display and keyboard.

As noted, aspects of the present invention may take the form of a computer program product embodied in one or more computer readable storage medium(s) having computer readable program code embodied thereon. A computer readable storage medium may be, for example, but not limited to, an electronic, magnetic, optical, electromagnetic, infrared, or semiconductor system, apparatus, or device, or any suitable combination of the foregoing. Media block 1118 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, asset monitoring modules as well as the spatio-temporal modules discussed above.

For example, asset monitoring modules may facilitate steps of obtaining position data of an asset, obtaining one or more context sensor signals. The spatio-temporal modules then may facilitate steps of updating a function that determines a present usage rate, estimating an asset time to failure, and adjusting a future asset task allocation. The method steps can then be carried out using distinct software modules and/or sub-modules of the system, executing on one or more hardware processors such as 1102. Further, a computer program product can include a computer-readable storage medium with code adapted to be implemented to carry out one or more method steps described herein, including the provision of the system with the distinct software modules. In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1.-14. (canceled)

15. A computer program product comprising a computer readable storage medium embodying computer executable instructions that when executed by a computer cause the computer to facilitate a method of:
obtaining position data of an asset;
obtaining one or more context sensor signals from the asset, each context sensor signal representing a real-time measured parameter related to the asset;
in near-real-time, updating a function that determines a present usage rate of the asset based on the position data, weighted values of the context sensor signals, and an immediate past usage status; and
in near-real-time, estimating an asset time to failure based on the updated function and a future asset task allocation.

16. The product of claim 15 wherein the method further includes, in near-real-time, adjusting the future asset task allocation based on the estimate of asset time to failure.

17. The product of claim 15 wherein the computer executable instructions also can cause the computer to maintain a history of usage rates correlated to position data.

18. The product of claim 15 wherein the computer executable instructions also can cause the computer to establish a vector of sensor weight factors based on a history of component usage.

19. An apparatus comprising:
a memory;
a plurality of sensors; and
at least one processor, coupled to said memory and said sensors, and operative to:
obtain position data of an asset;
obtain one or more context sensor signals from the plurality of sensors, each context sensor signal representing a real-time measured parameter related to the asset;
in near-real-time, update a function that determines a present usage rate of the asset based on the position data, weighted values of the context sensor signals, and an immediate past usage status; and
in near-real-time, estimate an asset time to failure based on the updated function and a future asset task allocation.

20. The apparatus of claim 19 wherein the processor also is operative to adjust the future asset task allocation in near-real-time based on the estimate of asset time to failure.
